(19) United States
(12) Patent Application Publication
(10) Pub. No.: US 2020/0031679 A1
(43) Pub. Date: Jan. 30, 2020

(54) SOUND ABSORBING MATERIAL, METHOD PROCESSING SAME AND SPEAKER BOX USING SAME

(71) Applicant: AAC Acoustic Technologies (Shenzhen) Co., Ltd., Shenzhen (CN)

(72) Inventors: Kun Tang, Shenzhen (CN); Hongshu Feng, Shenzhen (CN); Hezhi Wang, Shenzhen (CN); Guochuang Huang, Shenzhen (CN); Jiqiang Dai, Shenzhen (CN)

(21) Appl. No.: 16/522,695

(22) Filed: Jul. 26, 2019

(30) Foreign Application Priority Data
Jul. 28, 2018 (CN) 201810849846.0

(51) Int. Cl. C01B 39/08; H04R 1/02; G10K 11/162; C01B 39/04

(52) U.S. Cl. CPC C01B 39/082; H04R 1/02; G10K 11/162; C01P 2002/72; C01P 2002/52; C01P 2004/64; C01P 2004/30; C01B 39/04

(57) ABSTRACT

The present disclosure provides a sound absorbing material. The sound absorbing material includes a sound absorbing material comprising an MFL-structural-type molecular sieve, the MFL-structural-type molecular sieve comprising a skeleton, the skeleton comprising SiO₂ and Ga₂O₃, and the molar ratio of Si/Ga atoms in the skeleton is between 100 and 600. The invention also provides a method for preparing a sound absorbing material and a speaker box using the same. The sound absorbing material provided by the invention, the preparation method thereof and the speaker box using the sound absorbing material can further improve the performance of the speaker box, reduce the failure of the molecular sieve, and improve the performance stability of the lifting speaker box.

### FIELD OF THE DISCLOSURE

The present disclosure relates to a sound absorbing material, and more particularly to a sound absorbing material applied in speaker box, method preparing the sound absorbing material and a speaker box using the same.

### DESCRIPTION OF RELATED ART

With the development of science and technology and the improvement of living standards, people are imposing higher and higher requirements on performance of speaker boxes. In particular, for speaker boxes for mobile phones, it is required that the speaker box is as small as possible in volume but provides excellent acoustic performance. Sound quality of the speaker box is closely related to the design and manufacturing process, especially the size of the posterior cavity of the speaker box. Generally, the smaller the posterior cavity of the speaker box, the poorer the acoustic response in low-frequency bands, and the poorer the acoustic performance such as the sound quality. Therefore, it is necessary to attempt to enlarge the posterior cavity of the speaker box and enhance the acoustic response in the low-frequency bands.

In the related art, the posterior cavity of the speaker box is usually filled with porous carbon, silica, molecular sieves or the like sound absorbing materials to increase a virtual volume of the posterior cavity, improve the sound compliance of the posterior cavity gas, and thus to improve low-frequency performance. The molecular sieves achieve a best effect on improving the low-frequency performance.

However, common molecular sieves tend to absorb moisture in the air at room temperature and occupy micropores, thereby degrading the performance of the speaker. In addition, such molecular sieves are apt to absorb organic matters, thereby causing failure of the molecular sieves and resulting in low stability of the performance of the speaker.

Therefore, it is desired to provide a new and improved sound absorbing material and a speaker box using the same to address the above technical problems.

### BRIEF DESCRIPTION OF THE DRAWINGS

Various aspects of some exemplary embodiments may be better understood with reference to the accompanying drawings. The components in the drawings are not necessarily drawn to scale, and the emphasis is instead placed upon clearly illustrating the principles of the present disclosure. Moreover, in the drawings, like reference numerals designate corresponding parts throughout the several views.

FIG. 1 is a flowchart of a preparation method of a sound absorbing material according to the present disclosure;

FIG. 2 is an XRD pattern of MFL-structural-type molecular sieves according to Embodiment 1 of the present disclosure;

FIG. 3 is an XRD standard pattern of ZSM-5 according to the present disclosure; and

FIG. 4 is a schematic structural diagram a speaker box according to the present disclosure.

### DETAILED DESCRIPTION

The present disclosure will be hereinafter described in detail with reference to the accompanying drawings and exemplary embodiments thereof.

An embodiment of the present disclosure relates to a sound absorbing material. The sound absorbing material includes MFL-structural-type molecular sieves. The MFL-structural-type molecular sieves include frameworks. The frameworks include SiO₂ and Ga₂O₃, wherein a molar ratio of Si to Ga atoms in the frameworks is between 100 and 600, preferably between 150 and 550, and more preferably between 220 and 480.

Relative to the related art, in the embodiment of the present disclosure, since the MFL-structural-type molecular sieves include silica having uniformly distributed micropores, and the micropores absorb and desorb air molecules under the effect of sound pressure, and may increase a virtual volume of the acoustic cavity. After the MFL-structural-type molecular sieves are filled into the posterior cavity of the speaker, a low-frequency effect of the speaker may be remarkably improved, and low-frequency acoustic performance thereof may also be bettered.

Since the MFL-structural-type molecular sieves have a small volume, the MFL-structural-type molecular sieves may be filled into a smaller cavity. This addresses the problem that the acoustic cavity of the speaker is small and may not package the sound absorbing material, and thus accommodates the trend of miniaturization of the speaker.

According to the present disclosure, by introducing Ga into the frameworks of the molecular sieves and controlling and optimizing a molar ratio range of Si to Ga atoms in the molecular sieves, the MFL-structural-type molecular sieves which are not apt to absorb moisture and also absorb and desorb an increased amount of air are obtained. The low-frequency improvement effect and the low-frequency improvement performance stability of the molecular sieves are both better. The molar ratio of Si to Ga atoms in the molecular sieves is between from 100 to 600, preferably between 150 and 550, and more preferably between 220 and 480.

In addition, the MFL-structural-type molecular sieves further include extra-framework cations. The extra-framework cations are at least one of hydrogen ions, alkali metal ions or alkaline earth metal ions, which may effectively improve stability of the molecular sieves, such that performance stability of the speaker is improved.

It should be noted that when the molar ratio of Si to Ga is relatively low, for example, less than 100, the microporous structure achieving absorption and desorption effects in the MFI structure significantly adsorbs moisture in the air, and the moisture occupies the microporous channels of most MFL-structural-type molecular sieves. As a result, the low-frequency improvement effect is degraded. when the molar ratio of Si to Ga is too high, for example, greater than 600, the Ga content in the MFI structure is too low, the amount of cations introduced is too small, and organic compounds in the air and the speaker box are apt to enter channels of the molecular sieves to cause failure of the low-frequency improvement effect. Therefore, in this embodiment, the molar ratio of Si to Ga atoms is between 100 and 600, preferably between 150 and 550, more preferably between 220 and 480, such that the sound absorbing material has a better low-frequency improvement effect and a better low-frequency improved performance stability.

Specifically, in this embodiment, the molar ratio of Si to Ga atoms in the MFL-structural-type molecular sieves is between 100 to 600, preferably between 150 to 550, more preferably between 220 to 480. Under such circumstances, not only synthesis is less difficult, crystallinity is better, the low-frequency improvement effect is better, but also the stability of the low-frequency improvement performance is good.

In addition, the frameworks may further include a trivalent metal ion and/or a tetravalent metal ion oxide other than Ga₂O₃. In this embodiment, the frameworks further include an oxide of at least one of aluminum, chromium, iron, nickel, titanium, zirconium or hafnium. It would be understood by a person skilled in the art that the types of the trivalent metal ions and the tetravalent metal ions are not limited to the above examples, and may be other metal ions, and choice of such ions does affect the effects of the present disclosure.

It should be noted that in this embodiment, a particle size of MFL-structural-type molecular sieves is greater than 10 nm. Preferably, the particle size of the MFL-structural-type molecular sieves is greater than 10 nm and less than 10 μm. Since the MFL-structural-type molecular sieves have a small particle size, in practice, the MFL-structural-type molecular sieves need to be molded together with a binder to larger particles, which are suitable to be used as the sound absorbing material.

It is worth mentioning that, in this embodiment, the MFL-structural-type molecular sieves may be pure-phase MFI-structural-type molecular sieves. Since the pure-phase molecular sieves have a high purity, the speaker box with the posterior cavity being filled with the MFL-structural-type molecular sieves has better acoustic performance in low-frequency bands. Nevertheless, the MFL-structural-type molecular sieves may also be mixed-phase MFL-structural-type molecular sieves containing other phases such as MEL, BEA or the like, which, however, does not affect the effects of the present disclosure. Due to different synthesis methods, some of the obtained MFL-structural-type molecular sieves are mixed with a small amount of molecular sieves having the MEL, BEA or the like structure. These molecular sieve structures achieve certain low-frequency effects, but the microporous structure is slightly different and the low-frequency improvement performance is also different.

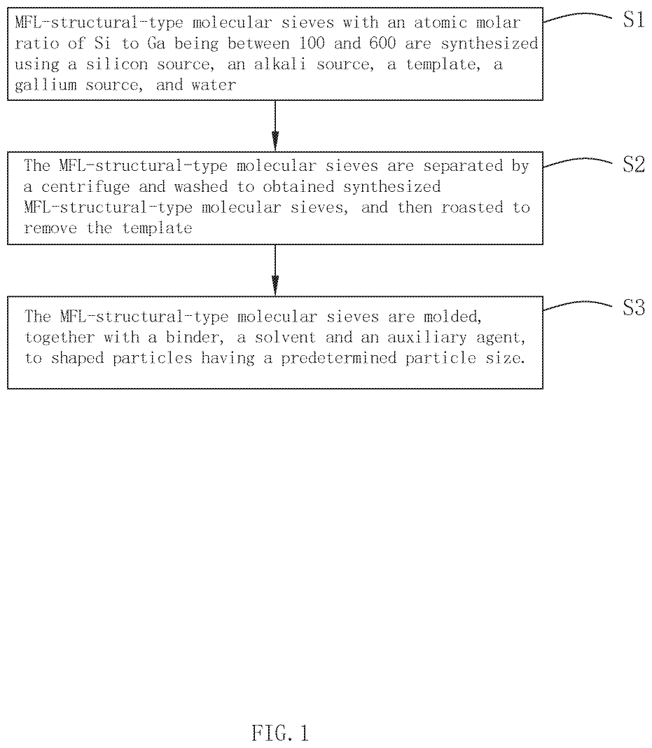

The present disclosure further provides a preparation method of the sound absorbing material, FIG. 1 illustrates a specific flowchart of the method. The preparation method includes the following steps:

Step S1: MFL-structural-type molecular sieves with an atomic molar ratio of Si to Ga being between 100 and 600 are synthesized using a silicon source, an alkali source, a template, a gallium source, and water.

In this step, when the effect is preferred, MFL-structural-type molecular sieves with the atomic molar ratio of Si to Ga being between 150 and 550, preferably, between 220 and 480, are synthesized.

With respect to step S1, specifically, starting material for the synthesis (the silicon source, the gallium source, the template, the alkali source and the like) are added to a synthesis reactor, and then MFL-structural-type molecular sieve powder is obtained by a crystallization reaction. The crystallization reaction is generally carried out in an aqueous phase for a specific period of time, which is also referred to as a hydrothermal reaction. The hydrothermal reaction is generally carried out at a temperature in the range of between the room temperature and 250° C., preferably in the range of between the room temperature and 180° C.; and the hydrothermal reaction is generally carried out under a pressure which is produced by a solvent with changes of the temperature thereof.

It should be noted that in this embodiment, the silicon source includes at least one of tetraethyl orthosilicate, silica sol or sodium silicate; the gallium source includes at least one of gallium oxide, gallium nitrate or gallium sulfate; the alkali source includes at least one of sodium hydroxide, potassium hydroxide, lithium hydroxide or organic alkali; the template is at least one of an organic amine or organic quaternary amine salt, a tetrapropyl quaternary ammonium salt or quaternary ammonium base, a tetrapropyl quaternary ammonium salt or quaternary ammonium base or a sodium dodecyl sulfate.

Step S2: The MFL-structural-type molecular sieves are separated by a centrifuge and washed to obtained synthesized MFL-structural-type molecular sieves, and then roasted to remove the template.

With respect to step S2, the specific period of time is a hydrothermal reaction time period, which is generally from half an hour to several months, preferably from 4 hours to 240 hours. The particle size of the MFL-structural-type molecular sieves experiencing the hydrothermal reaction is controlled to be between 5 nm and 20 μm, preferably between 10 nm to 10 μm; and the roasting is carried out in a temperature in the range of between 350° C. to 850° C., preferably between 500° C. to 700° C.

Step S3: The MFL-structural-type molecular sieves are molded, together with a binder, a solvent and an auxiliary agent, to shaped particles having a predetermined particle size.

With respect to step S3, specifically, since the particle size of the MFL-structural-type molecular sieves molded in step S2 is too small, if the MFL-structural-type molecular sieves are directly filled into the posterior cavity of the speaker box as the sound absorbing material, the MFL-structural-type molecular sieves are apt leak out of the filling region, thereby affecting normal use of the speaker box. Therefore, in step S3, the binder is added to the MFL-structural-type molecular sieves to mold the shaped particulate molecular sieves, such that the MFL-structural-type molecular sieves are suitable to be filled as the sound absorbing material. The molded particles have a particle preferably of between 10 μm and 1000 μm, more preferably of between 80 μm to 500 μm. The binder is mainly divided into an inorganic binder and an organic polymer binder. The inorganic binder may be selected from activated alumina, silica sol or the like; and the organic polymer binder may be selected from an acrylate binder or an epoxy binder, a polyurethane binder or the like. The solvent mainly refers to water and various common organic solvents, such as ethanol, toluene, acetone, tetrahydrofuran or the like. The auxiliary refer to other substances added in a small amount, generally less than 5%.

It is worth mentioning that, upon step S2 and prior to step S3, a step of cation exchange of the MFL-structural-type molecular sieves may be further performed to obtain different types of MFL-structural-type molecular sieves. This step may be carried out using an ammonium salt, a monovalent copper salt, a monovalent silver salt, a monovalent gold salt, an alkali metal salt or an alkaline earth metal salt, and exchanged with the molecular sieves. The ammonium salt may be ammonium chloride, ammonium nitrate, ammonium sulfate, ammonium carbonate or the like; the copper salt may be cuprous chloride; the silver salt may be silver nitrate; the alkali metal salt may be a lithium salt, a sodium salt, a potassium salt, a barium salt or the like; anions of the alkali metal salt may be chloride ions, sulfate ions, nitrate ions or the like; the alkaline earth metal may be a magnesium salt, a calcium salt, a barium salt or the like; and anions of the alkali metal salt may be chloride ions, sulfate ions, nitrate ions or the like.

The embodiment of the present disclosure will be explained hereinafter in connection with specific examples.

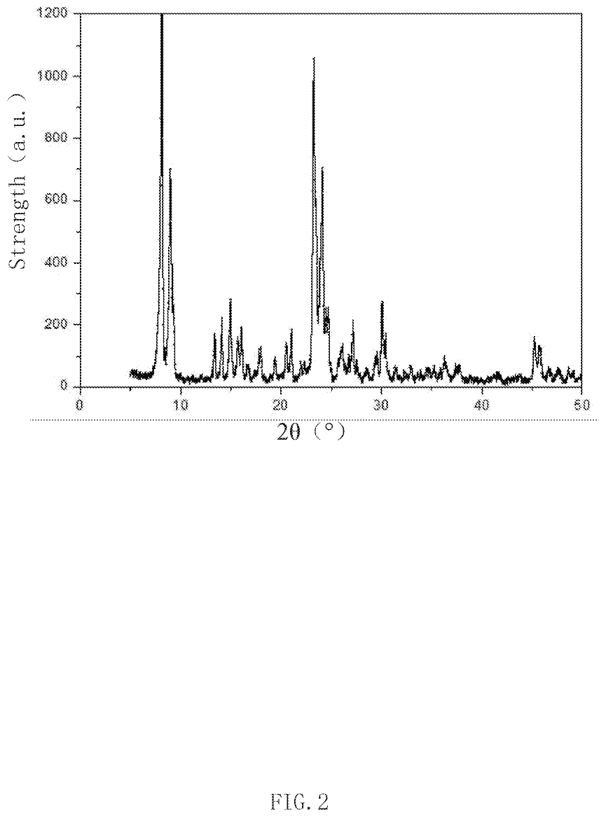

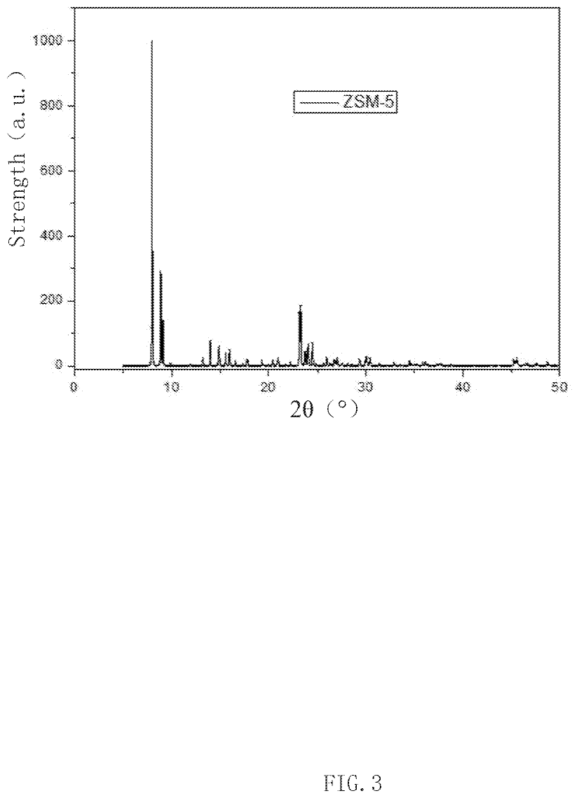

In Embodiment 1 of the preparation method of the sound absorbing material, the MFL-structural-type molecular sieves with a molar ratio of Si to Ga being 100 were synthesized using a silicon source, a gallium source, an alkali source, a template and water. The template is at least one of tetrapropyl ammonium bromide, tetrapropyl ammonium hydroxide, tetrapropyl ammonium chloride, tetrapropyl ammonium iodide or tetrapropyl ammonium fluoride. FIG. 2 illustrates an XRD pattern of the MFL-structural-type molecular sieves. FIG. 3 illustrates a standard XRD pattern of ZSM-5. By comparison, it is apparent that positions of characteristic peaks in FIG. 2 and FIG. 3 are identical.

In Embodiment 2 of the preparation method of the sound absorbing material, the MFL-structural-type molecular sieves with a molar ratio of Si to Ga being 100 were synthesized using a silicon source, a gallium source, an alkali source, a template and water. The template is at least one of tetrapropyl ammonium bromide, tetrapropyl ammonium hydroxide, tetrapropyl ammonium chloride, tetrapropyl ammonium iodide or tetrapropyl ammonium fluoride. A Sodium-type MFI structure was obtained by exchange using a sodium salt. The sodium salt includes at least one of sodium chloride, sodium sulfate, sodium nitrate, but is not limited to these salts.

In Embodiment 3 of the preparation method of the sound absorbing material, the MFL-structural-type molecular sieves with a molar ratio of Si to Ga being 100 were synthesized using a silicon source, a gallium source, an alkali source, a template and water. The template agent is at least one of tetrapropyl ammonium bromide, tetrapropyl ammonium hydroxide, tetrapropyl ammonium chloride, tetrapropyl ammonium iodide or tetrapropyl ammonium fluoride. A silver cuprous-type MFI structure was obtained by exchange using a cuprous salt. The cuprous salt is cuprous chloride, but it is not limited to this salt.

In Embodiment 4 of the preparation method of the sound absorbing material, the MFL-structural-type molecular sieves with a molar ratio of Si to Ga being 200 were synthesized using a silicon source, a gallium source, an alkali source, a template and water. The template is at least one of tetrapropyl ammonium bromide, tetrapropyl ammonium hydroxide, tetrapropyl ammonium chloride, tetrapropyl ammonium iodide or tetrapropyl ammonium fluoride.

In Embodiment 5 of the preparation method of the sound absorbing material, the MFL-structural-type molecular sieves with a molar ratio of Si to Ga being 300 were synthesized using a silicon source, a gallium source, an alkali source, a template agent and water. The template is at least one of tetrapropyl ammonium bromide, tetrapropyl ammonium hydroxide, tetrapropyl ammonium chloride, tetrapropyl ammonium iodide or tetrapropyl ammonium fluoride.

In Embodiment 6 of the preparation method of the sound absorbing material of the invention, the MFL-structural-type molecular sieves with a molar ratio of Si to Ga being 400 were synthesized using a silicon source, a gallium source, an alkali source, a template agent and water. The template agent is at least one of tetrapropyl ammonium bromide, tetrapropyl ammonium hydroxide, tetrapropyl ammonium chloride, tetrapropyl ammonium iodide or tetrapropyl ammonium fluoride.

In a Comparative Example 1 of the preparation method of the sound absorbing material. MFL-structural-type molecular sieves with a molar ratio of Si to Ga being 60 were synthesized using a silicon source, a gallium source, an alkali source, a template and water. The template agent is at least one of tetrapropyl ammonium bromide, tetrapropyl ammonium hydroxide, tetrapropyl ammonium chloride, tetrapropyl ammonium iodide or tetrapropyl ammonium fluoride.

In Comparative Example 2 of the preparation method of the sound absorbing material, MFL-structural-type molecular sieves with a molar ratio of Si to Ga being 650 were synthesized using a silicon source, a gallium source, an alkali source, a template, and water. The template agent is at least one of tetrapropylammonium bromide, tetrapropylammonium hydroxide, tetrapropylammonium chloride, tetrapropylammonium iodide or tetrapropylammonium fluoride.

The molecular sieves synthesized in Embodiments 1 to 6 and Comparative Examples 1 to 2 according to the present disclosure were separately mixed with a solvent, a binder and an auxiliary to prepare a suspension mixture, and the suspension mixture was dried and pulverized to obtain a particle-like molecular sieves. Afterwards, the particle-like molecular sieves were filled into the then filled into the posterior cavity (the volume is 1 cm³ upon assembling, which is referred to as 1 cc for short) of the speaker. An acoustic performance test is carried out. Table 1 illustrates test results.

The speaker box (including the posterior cavity and the sound absorbing material) was placed to a 95° C. environment for operation, an ageing test was carried out, acoustic performance before and after the ageing test is tested, which is referred to as high-temperature frequency sweep for short. Table 2 illustrates test results.

TABLE 1
Resonance frequency F0 and Q before and after
the molecular sieves are filled into the posterior
cavity of the speaker box

| | 1 CC | | | | | |
|---|---|---|---|---|---|---|
| | | | After Adding | | | |
| | | | 1 cc | | | |
| | | | Low-frequency | | | |
| | | | improvement | | | |
| | Cavity | | Material | | Reduce Value | |
| Sample | F₀ (Hz) | Q | F₀ (Hz) | Q | ΔF₀ (Hz) | ΔQ |
| Embodiment 1 | 908 | 1.4 | 650 | 0.6 | 255 | 0.8 |
| Embodiment 2 | 909 | 1.4 | 648 | 0.5 | 257 | 0.9 |
| Embodiment 3 | 908 | 1.5 | 655 | 0.7 | 255 | 0.8 |
| Embodiment 4 | 910 | 1.4 | 652 | 0.7 | 258 | 0.7 |
| Embodiment 5 | 909 | 1.5 | 648 | 0.6 | 261 | 0.9 |
| Embodiment 6 | 909 | 1.4 | 646 | 0.7 | 263 | 0.7 |
| Comparative | 908 | 1.5 | 788 | 0.7 | 120 | 0.8 |
| Example 1 | | | | | | |
| Comparative | 910 | 1.4 | 650 | 0.6 | 260 | 0.8 |
| Example 2 | | | | | | |

TABLE 2
Low-frequency imporvement performance differences ΔF0 before
and after high-frequency sweep with the low-frequency improved
material filled into in the posterior cavity of the speaker

| | High-temperature freqency sweep | | |
|---|---|---|---|
| | | | Difference value |
| | ΔF₀(Hz) before | ΔF0(Hz) after | ΔF₀ before and |
| Sample | experiment | experiment | after experiment (Hz) |
| Embodiment 1 | 100 | 76 | 24 |
| Embodiment 2 | 101 | 79 | 22 |
| Embodiment 3 | 100 | 77 | 23 |
| Embodiment 4 | 103 | 82 | 21 |
| Embodiment 5 | 105 | 83 | 22 |
| Embodiment 6 | 108 | 85 | 23 |
| Comparative | 48 | 25 | 23 |
| Example 1 | | | |
| Comparative | 102 | 50 | 52 |
| Example 2 | | | |

According to Table 1, it may be concluded that after the molecular sieves obtained in Embodiments 1 to 6 are filled into the posterior cavity of the speaker, the resonance frequencies F0 and Q values of the speaker are greatly reduced. According to Table 2, it may be concluded that the molecular sieves obtained in Embodiments 1 to 6 have a good low frequency improvement effect on the speaker after the high-temperature frequency sweep; after the molecular sieves obtained in Comparative Example 1 are filled into the posterior cavity of the speaker, the resonance frequency of the speaker is less reduced, and the low-frequency improvement performance was poor; after the molecular sieves obtained in Comparative Example 2 are filled into the posterior cavity of the speaker and subjected to the high-temperature frequency sweep and the aging test, the resonance frequency is significantly reduced and the performance stability is poor.

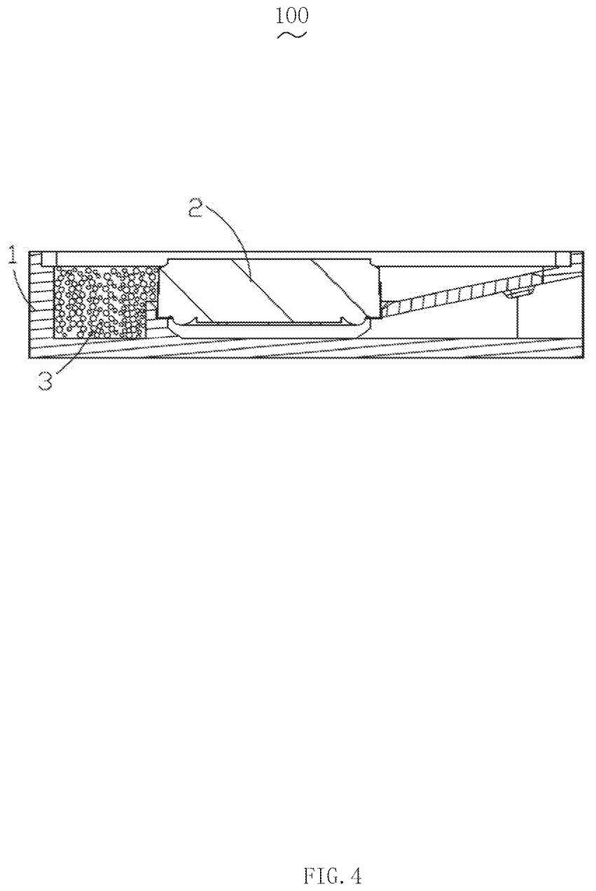

The present disclosure further provides a speaker box 100. As illustrated in FIG. 4, the speaker box 100 includes a housing 1 having receiving space, a speaker 2 accommodating in the housing 1, and a posterior cavity 3 defined by the speaker 2 and the housing 1. The sound absorbing material is filled into a posterior cavity 3 to enhance the acoustic compliance of the air in the posterior cavity 3 and to improve the low-frequency performance of the speaker box 100.

Compared with the relevant art, for the sound absorbing material according to the present disclosure, since the MFL-structural-type molecular sieves include silica having a plurality of uniformly distributed microporous, and the microporous absorb and desorb air molecules under the effect of sound pressure. The microporous structure of the MFL-structural-type molecular sieves may increase a virtual volume of the acoustic cavity. When the MFL-structural-type molecular sieves are filled into the posterior cavity of the speaker box, the low-frequency effect of the speaker system may be significantly improved and the low-frequency performance may be improved. Since the MFL-structural-type molecular sieves have a small particle size, the MFL-structural-type molecular sieves may be filled into a smaller cavity. This addresses that the acoustic cavity of the speaker box is small and may not package the sound absorbing material, and thus accommodates the trend of miniaturization of the speaker box.

By introducing Ga into the frameworks of the molecular sieves and controlling and optimizing a molar ratio range of Si to Ga atoms in the optimized molecular sieve, the MFL-structural-type molecular sieves which are not apt to absorb moisture and also absorb and desorb an increased amount of air are obtained. The low-frequency improvement effect and the low-frequency improvement performance stability of the molecular sieves are both better. The molar ratio of Si to Ga atoms in the molecular sieves is between from 100 to 600, preferably between 150 and 550, and more preferably between 220 and 480

It is to be understood, however, that even though numerous features and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A sound absorbing material, comprising MFI-structural-type molecular sieves, the MFI-structural-type molecular sieves comprise frameworks skeletons, the frameworks comprising SiO2 and Ga2O3, wherein a molar ratio of Si to Ga atoms in the framework is between 100 and 600.

2. The sound absorbing material according to claim 1, wherein the frameworks further comprise trivalent and/or tetravalent metal ion oxides other than Ga2O3.

3. The sound absorbing material according to claim 2, wherein the frameworks further comprise an oxide of at least one of aluminum, chromium, iron, nickel, titanium, zirconium or germanium.

4. The sound absorbing material according to claim 1, Wherein the MFL-structural-type molecular sieves further comprise extra-framework cations.

5. The sound absorbing material according to claim 4, wherein the extra-framework cations comprise at least one of hydrogen ions, alkali metal ions or alkaline earth metal ions.

6. The sound absorbing material according to claim 5, wherein a molar ratio of Si to Ga atoms in the frameworks is between 150 and 550.

7. The sound absorbing material according to claim 1, wherein a molar ratio of Si to Ga atoms in the frameworks is between 220 and 480.

8. The sound absorbing material according to claim 1, wherein a particle size of the MFL-structural-type molecular sieves is greater than 10 nm.

9. The sound absorbing material as described in claim 1, wherein a particle size of the MFL-structural-type molecular sieves is less than 10 μm.

10. The sound absorbing material according to claim 1, wherein the MFL-structural-type molecular sieves comprise pure-phase MFL-structural-type molecular sieves or mixed-phase MFL-structural-type molecular sieves.

11. The sound absorbing material as described in claim 2, wherein the MFL-structural-type molecular sieves comprises a pure phase MFL-structural-type molecular sieves or a mixed phase MEL-structural-type molecular sieves.

12. The sound absorbing material as described in claim 3, wherein the MEL-structural-type molecular sieves comprises a pure phase MEL-structural-type molecular sieves or a mixed phase MFL-structural-type molecular sieves.

13. The sound absorbing material as described in claim 4, wherein the MEL-structural-type molecular sieves comprises a pure phase MFL-structural-type molecular sieves or a mixed phase MFL-structural-type molecular sieves.

14. The sound absorbing material as described in claim 5, wherein the MFL-structural-type molecular sieves comprises a pure phase MEL-structural-type molecular sieves or a mixed phase MFL-structural-type molecular sieves.

15. The sound absorbing material as described in claim 6, wherein the MEL-structural-type molecular sieves comprises a pure phase MEL-structural-type molecular sieves or a mixed phase MEL-structural-type molecular sieves.

16. The sound absorbing material as described in claim 7, wherein the MEL-structural-type molecular sieves comprises a pure phase MIF-structural-type molecular sieves or a mixed phase MFL-structural-type molecular sieves.

17. The sound absorbing material as described in claim 8, wherein the MFL-structural-type molecular sieves comprises a pure phase MEL-structural-type molecular sieves or a mixed phase MEL-structural-type molecular sieves.

18. A preparation method of a sound absorbing material, comprising:
synthesizing MEL-structural-type molecular sieves with an atomic molar ratio of Si to Ga between 100 and 600 using a silicon source, an alkali source, a template, a gallium source and water;
separating the MEL-structural-type molecular sieves by a centrifuge and washing the MEL-structural-type molecular sieves to obtain synthesized MFL-structural-type molecular sieves and roasting to remove the template;
molding the MFL-structural-type molecular sieves with a binder, a solvent and an auxiliary to shaped particles having a predetermined particle size.

19. The preparation method of a sound absorbing material according to claim 18, wherein the template is one or more of an organic amine, an organic ammonium salt or an organic base.

20. A speaker box, comprising:
a housing having a receiving space;
a speaker disposed in the housing; and
a posterior cavity defined by the speaker and the housing;
wherein the posterior cavity is filled with the sound absorbing material as defined in claim 1.
